(19) United States
(12) Patent Application Publication
(10) Pub. No.: US 2012/0028028 A1
(43) Pub. Date: Feb. 2, 2012

(54) MANUFACTURING METHOD OF CONDUCTIVE THIN FILM AND PRODUCT THEREOF

(75) Inventor: CHIH-HAO HUANG, Tu Cheng (TW)

(73) Assignee: Cheng Uei Precision Industry Co., LTD., Tu Cheng City (TW)

(21) Appl. No.: 12/848,159

(22) Filed: Jul. 31, 2010

(51) Int. Cl. B32B 3/26; H01B 1/22; H01B 1/24; B05D 5/12; H01B 1/00

(52) U.S. Cl. 428/315.5; 427/58; 427/125; 427/123; 427/122; 427/126.3; 252/500; 252/510; 252/512; 252/514; 428/317.9

(57) ABSTRACT

A manufacturing method of conductive thin film includes: (A) preparing tetraethyl orthosilicate (TEOS), 3-methacryloxypropyl-trimethoxysilane and one of or a mixture of vinyl-triethoxysilane (VTEO) and vinyl-trimethoxysilane (VTMO) in a mole ratio of 1:1:1, so as to obtain a silicon-containing reactant; (B) mixing the silicon-containing reactant with a solvent containing water and alcohol, wherein the total quantity of moles of the solvent is two times of that of the silicon-containing reactant; and evenly stirring for at least 12 hours, so as to obtain a semi-finished paint; (C) adding a conductive material in an amount of 3-50 wt % based on a final total weight into the semi-finished paint and evenly stirring, so as to obtain a finished paint; and (D) applying the finished paint to a substrate by coating means, and heating at a temperature of 70-250° C. for 5-60 minutes, so as to form a conductive thin film with continuous pores.

### FIELD OF THE INVENTION

The present invention relates to a technology of conductive thin film, and more particularly to a manufacturing method of conductive thin film and a product thereof.

### BACKGROUND OF THE INVENTION

Recently, the market share of touch panel applications is continuously increased, so that touch panels are widely applied to various mobile phones and computer displays, and the need of the transparent conductive thin film is considerably increased. The most widely used conductive thin film is indium tin oxides (ITO) film of a conductive glass. However, the type of conductive glass with the ITO thin film can not satisfy the needs of flexibility and bendability for the applications of new developed products.

According to a traditional manufacturing method of conductive thin film, a macromolecular thin film made of poly(ethylene terephthalate) (i.e. PET) or polyimide (PI) is coated with a metallic conductive ink to form the conductive thin film which can provide an excellent conductivity and satisfy the needs of flexibility and bendability.

However, the metal material used by the metallic conductive ink is colored and non-transparent, so that the metallic conductive ink coated on the conductive thin film may affect the optical transmittance of the conductive thin film. In addition, the metal material is expensive. For the same coating area, the traditional manufacturing method of the conductive thin film can not efficiently reduce the use of the metal material in a case that the conductive thin film must maintain a good conductivity.

### SUMMARY OF THE INVENTION

A primary object of the present invention is to provide a manufacturing method of conductive thin film and a product thereof, so as to solve the problems existing in the foregoing traditional technology and to lower the manufacture cost of the conductive thin film and enhance the optical transmittance thereof.

To achieve the above object, a manufacturing method of conductive thin film and product thereof provided by the present invention comprises the following steps:

(A) preparing tetraethyl orthosilicate (TEOS), 3-methacryloxypropyl-trimethoxysilane and one of or a mixture of vinyl-triethoxysilane (VTEO) and vinyl-trimethoxysilane (VTMO) in a mole ratio of 1:1:1, so as to obtain a silicon-containing reactant;

(B) mixing the silicon-containing reactant of step (A) with a solvent containing water and alcohol, wherein the total quantity of moles of the solvent is two times of that of the silicon-containing reactant; and evenly stirring a mixture of the silicon-containing reactant and the solvent for at least 12 hours, so as to obtain a semi-finished paint;

(C) adding a conductive material in an amount of 3-50 wt % based on a final total weight into the semi-finished paint, and evenly stirring a mixture of the semi-finished paint and the conductive material, so as to obtain a finished paint; and

(D) applying the finished paint onto a substrate by coating means, and heating the finished paint on the substrate under the temperature condition of 70-250° C. for 5-60 minutes, so as to form a conductive thin film with continuous pores on a surface of the substrate.

Furthermore, a conductive thin film of the present invention is manufactured by the foregoing manufacturing method of conductive thin film.

As described above, the conductive thin film manufactured by the foregoing manufacturing method of conductive thin film of the present invention has the continuous pores, so that the conductive thin film is advantageous to enhance the optical transmittance in the case of maintaining a good conductivity. Meanwhile, for the same coating area, the manufacturing method is advantageous to reduce the use of the conductive material and thus lower the manufacture cost of the conductive thin film.

### DETAILED DESCRIPTION OF THE PREFERRED EMBODIMENTS

The structure and the technical means adopted by the present invention to achieve the above and other objects can be best understood by referring to the following detailed description of the preferred embodiments.

A manufacturing method of conductive thin film according to a preferred embodiment of the present invention comprises the following steps:

(A) preparing tetraethyl orthosilicate (TEOS), 3-methacryloxypropyl-trimethoxysilane and one of or a mixture of vinyl-triethoxysilane (VTEO) and vinyl-trimethoxysilane (VTMO) in a mole ratio of 1:1:1, so as to obtain a silicon-containing reactant;

(B) mixing the silicon-containing reactant of step (A) with a solvent containing water and alcohol, wherein the total quantity of moles of the solvent is two times of that of the silicon-containing reactant; and evenly stirring a mixture of the silicon-containing reactant and the solvent for at least 12 hours, so as to obtain a semi-finished paint;

(C) adding a conductive material in an amount of 3-50 wt % based on a final total weight of a conductive thin film into the semi-finished paint, and evenly stirring a mixture of the semi-finished paint and the conductive material, so as to obtain a finished paint; wherein the particle size of the conductive material is not greater than 1000 μm, and the conductive material is at least one of sliver (Ag), copper (Cu), carbon nanotubes (CNTs), graphite, conductive carbon black, conductive metal oxides and conducting polymer; and

(D) applying the finished paint onto a substrate by coating means, and heating the finished paint on the substrate under the temperature condition of 70-250° C. for 5-60 minutes, so as to form a conductive thin film with continuous pores on a surface of the substrate; wherein the pore size of the pores is ranged between 100 and 5000 μm; the coating means can be spin coating, immersion coating or spray coating; the substrate can be a plastic substrate or a glass substrate, wherein the material of the plastic substrate is one of polycarbonate (PC), acrylonitrile-butadiene-styrene copolymer (ABS), poly(methylmethacrylate) (i.e. PMMA), polyphenylene ether (PPO), poly(ethylene terephthalate) (i.e. PET), polyamide (PA), styrene-ethylene-butylene-styrene copolymer (SEBS), thermoplastic polyurethane (TPU), polyvinylchloride (PVC) and polyimide (PI).

Furthermore, a conductive thin film of the present invention is manufactured by the foregoing manufacturing method of conductive thin film.

According to the present invention, two embodiments for the manufacturing method of conductive thin film are described as follows:

The first embodiment comprises the following steps:

(A) firstly, preparing reactants including 0.1 mol (20.83 g) of tetraethyl orthosilicate (TEOS), 0.1 mol (24.84 g) of 3-methacryloxypropyl-trimethoxysilane and 0.1 mol (19.03 g) of vinyl-triethoxysilane (VTEO) in a mole ratio of 1:1:1, so as to obtain a silicon-containing reactant;

(B) mixing the silicon-containing reactant of step (A) with a solvent containing 0.6 mol (10.8 g) of water and 0.6 mol (27.6 g) of 99% alcohol, and evenly stirring a mixture of the silicon-containing reactant and the solvent at room temperature for 24 hours, so as to obtain a semi-finished paint;

(C) adding a conductive silver particles (particle size being 50-200 nm) in an amount of 30 wt % based on a final total weight into the semi-finished paint and evenly stirring a mixture of the semi-finished paint and the conductive silver particles, so as to obtain a finished paint;

(D) applying the finished paint of step (C) onto a PC substrate by means of immersion coating, and heating the finished paint on the substrate under the temperature condition of 120° C. for 10 minutes, so as to form a conductive thin film with continuous pores (pore size being 500-2000 μm) on a surface of the PC substrate.

The second embodiment comprises the following steps:

(A) firstly, preparing reactants including 0.1 mol (20.83 g) of tetraethyl orthosilicate (TEOS), 0.1 mol (24.84 g) of 3-methacryloxypropyl-trimethoxysilane and 0.1 mol (14.82 g) of vinyl-trimethoxysilane (VTMO) in a mole ratio of 1:1:1, so as to obtain a silicon-containing reactant;

(B) mixing the silicon-containing reactant of step (A) with a solvent containing 0.6 mol (10.8 g) of water and 0.6 mol (27.6 g) of 99% alcohol, and evenly stirring a mixture of the silicon-containing reactant and the solvent at room temperature for 24 hours, so as to obtain a semi-finished paint;

(C) adding a conductive copper particles (particle size being 100-300 nm) in an amount of 20 wt % based on a final total weight into the semi-finished paint and evenly stirring a mixture of the semi-finished paint and the conductive copper particles, so as to obtain a finished paint;

(D) applying the finished paint of step (C) onto a PC substrate by means of immersion coating, and heating the finished paint on the substrate under the temperature condition of 120° C. for 10 minutes, so as to form a conductive thin film with continuous pores (pore size being 1500-3000 μm) on a surface of the PC substrate.

As described above, the conductive thin film manufactured by the foregoing manufacturing method of conductive thin film of the present invention has the continuous pores, so that the conductive thin film is advantageous to enhance the optical transmittance in the case of maintaining a good conductivity. Meanwhile, for the same coating area, the manufacturing method is advantageous to reduce the use of the conductive material and thus lower the manufacture cost of the conductive thin film.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A manufacturing method of conductive thin film, comprising:
(A) preparing tetraethyl orthosilicate (TEOS), 3-methacryloxypropyl-trimethoxysilane and one of or a mixture of vinyl-triethoxysilane (VTEO) and vinyl-trimethoxysilane (VTMO) in a mole ratio of 1:1:1, so as to obtain a silicon-containing reactant;
(B) mixing the silicon-containing reactant of step (A) with a solvent containing water and alcohol, wherein the total quantity of moles of the solvent is two times of that of the silicon-containing reactant; and evenly stirring a mixture of the silicon-containing reactant and the solvent for at least 12 hours, so as to obtain a semi-finished paint;
(C) adding a conductive material in an amount of 3-50 wt % based on a final total weight into the semi-finished paint, and evenly stirring a mixture of the semi-finished paint and the conductive material, so as to obtain a finished paint; and
(D) applying the finished paint onto a substrate by coating means, and heating the finished paint on the substrate under the temperature condition of 70-250° C. for 5-60 minutes, so as to form a conductive thin film with continuous pores on a surface of the substrate.

2. The manufacturing method of conductive thin film according to claim 1, wherein stirring of step (B) is carried out for 24 hours.

3. The manufacturing method of conductive thin film according to claim 1, wherein the conductive material of step (C) is at least one of sliver, copper, carbon nanotubes, graphite, conductive carbon black, conductive metal oxides and conducting polymer.

4. The manufacturing method of conductive thin film according to claim 1, wherein the conductive material of step (C) has a particle size which is not greater than 1000 μm.

5. The manufacturing method of conductive thin film according to claim 3, wherein the conductive material of step (C) has a particle size which is not greater than 1000 μm.

6. The manufacturing method of conductive thin film according to claim 1, wherein the coating means of step (D) is spin coating, immersion coating or spray coating.

7. The manufacturing method of conductive thin film according to claim 1, wherein the pores of step (D) have a pore size which ranges between 100 and 5000 μm.

8. The manufacturing method of conductive thin film according to claim 6, wherein the pores of step (D) have a pore size which ranges between 100 and 5000 μm.

9. A conductive thin film, which is manufactured by the manufacturing method of conductive thin film according to claim 1.

10. A conductive thin film, which is manufactured by the manufacturing method of conductive thin film according to claim 2.

11. A conductive thin film, which is manufactured by the manufacturing method of conductive thin film according to claim 3.

12. A conductive thin film, which is manufactured by the manufacturing method of conductive thin film according to claim 4.

13. A conductive thin film, which is manufactured by the manufacturing method of conductive thin film according to claim 5.

14. A conductive thin film, which is manufactured by the manufacturing method of conductive thin film according to claim 6.

15. A conductive thin film, which is manufactured by the manufacturing method of conductive thin film according to claim 7.

16. A conductive thin film, which is manufactured by the manufacturing method of conductive thin film according to claim 8.
